(19) United States
(12) Patent Application Publication
(10) Pub. No.: US 2010/0320636 A1
(43) Pub. Date: Dec. 23, 2010

(54) FIBER-CONTAINING THERMOPLASTIC RESIN COMPOSITION AND PROCESS FOR PRODUCING THE SAME

(75) Inventor: Kenji ATARASHI, Kimitsu-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Tokyo (JP)

(21) Appl. No.: 12/796,699

(22) Filed: Jun. 9, 2010

(30) Foreign Application Priority Data
Jun. 19, 2009 (JP) 2009-146102

(51) Int. Cl. B29C 67/00; C08L 35/02

(52) U.S. Cl. 264/134; 525/225

(57) ABSTRACT

A thermoplastic resin composition comprising (i) 55 to 95 parts by weight of a thermoplastic resin, and (ii) 5 to 45 parts by weight of a fiber containing 10 to 100% by weight of a diameter-varying fiber which has an enlarged diameter at its one or both ends; and a production process thereof comprising the steps of (1) cutting a continuous fiber under the condition that its cutting spot is heated to its melting temperature or higher, thereby preparing a diameter-varying fiber, and (2) melt-kneading a mixture containing the diameter-varying fiber and a thermoplastic resin.

### FIELD OF THE INVENTION

The present invention relates to a fiber-containing thermoplastic resin composition, and a process for producing such a resin composition.

### BACKGROUND OF THE INVENTION

There have been developed a lot of fiber-containing thermoplastic resin compositions comprising a thermoplastic resin and a fiber, in order to improve mechanical strength of the thermoplastic resin, such as stiffness and impact resistance. For example, JP 2001-49012A discloses an organic fiber-reinforced resin composition containing a polyolefin resin and a synthetic organic fiber. Also, JP 2005-272754A, JP 2006-8995A and JP 2006-233379A disclose a fiber-containing polyolefin resin composition, which comprises a polypropylene resin and a polyethylene naphthalenedicarboxylate fiber, and has improved mechanical strength and heat resistance.

These patent documents disclose that the longer a fiber contained in a resin composition is, the higher the resin composition is in its mechanical strength such as falling-weight-impact strength and flexural strength. Therefore, various kinds of efforts have been made, such as a modification of a screw design of an injection molding machine for molding a resin composition, in order to avoid cutoff of a fiber during molding the resin composition.

### SUMMARY OF THE INVENTION

However, it is difficult, even through those efforts, to sufficiently avoid cutoff of a fiber in order to obtain a resin composition having desired mechanical strength.

In view of the above circumstance, an object of the present invention is to provide a fiber-containing thermoplastic resin composition improved in its falling-weight-impact strength, and a process for producing such a resin composition.

The present invention is a thermoplastic resin composition comprising:
55 to 95 parts by weight of a thermoplastic resin; and
5 to 45 parts by weight of a fiber containing 10 to 100% by weight of a diameter-varying fiber which has an enlarged diameter at its one or both ends;
   provided that the total of the thermoplastic resin and the fiber contained in the thermoplastic resin composition is 100 parts by weight, and the total of the fiber contained in the thermoplastic resin composition is 100% by weight.

Also, the present invention is a process for producing a thermoplastic resin composition comprising:
55 to 95 parts by weight of a thermoplastic resin; and
5 to 45 parts by weight of a fiber containing 10 to 100% by weight of a diameter-varying fiber which has an enlarged diameter at its one or both ends;
   provided that the total of the thermoplastic resin and the fiber contained in the thermoplastic resin composition is 100 parts by weight, and the total of the fiber contained in the thermoplastic resin composition is 100% by weight, the process comprising the steps of:

(1) cutting a continuous fiber under the condition that its cutting spot is heated to its melting temperature or higher, thereby preparing a diameter-varying fiber; and

(2) melt-kneading a mixture containing the diameter-varying fiber and a thermoplastic resin.

Further, the present invention is a process for producing a thermoplastic resin composition pellet comprising:
55 to 95 parts by weight of a thermoplastic resin; and
5 to 45 parts by weight of a fiber containing 10 to 100% by weight of a diameter-varying fiber which has an enlarged diameter at its one or both ends;
   provided that the total of the thermoplastic resin and the fiber contained in the thermoplastic resin composition is 100 parts by weight, and the total of the fiber contained in the thermoplastic resin composition is 100% by weight, the process comprising the steps of:

(1) impregnating a continuous fiber bundle with a thermoplastic resin under drawing the continuous fiber bundle, thereby preparing a thermoplastic resin-impregnated continuous fiber bundle; and

(2) cutting the thermoplastic resin-impregnated continuous fiber bundle under the condition that its cutting spot is heated to melting temperature of the fiber, or higher.

Furthermore, the present invention is a process for producing a thermoplastic resin composition pellet comprising:
55 to 95 parts by weight of a thermoplastic resin; and
5 to 45 parts by weight of a fiber containing 10 to 100% by weight of a diameter-varying fiber which has an enlarged diameter at its one or both ends, the process comprising the steps of:

(1) impregnating a continuous fiber bundle with a thermoplastic resin under drawing the continuous fiber bundle, thereby preparing a thermoplastic resin-impregnated continuous fiber bundle;

(2) cutting the thermoplastic resin-impregnated continuous fiber bundle under the condition that its cutting spot has temperature lower than melting temperature of the fiber, thereby preparing a pellet; and

(3) heating one or two cut ends of the pellet at melting temperature of the fiber, or higher.

The above three production processes are referred to hereinafter as “process-1” “process-2” and “process-3” in order.

### BRIEF DESCRIPTION OF THE DRAWINGS

FIG. 1 shows an optical photomicrograph of a diameter-varying fiber used in Example 1, wherein 1 is a diameter-varying fiber, and 2 is its diameter-enlarged part.

FIG. 2 shows an optical photomicrograph of a fiber used in Comparative Example 1.

### DETAILED DESCRIPTION OF THE INVENTION

A thermoplastic resin in the present invention is not particularly limited, and may be a resin known in the art.

Examples of the thermoplastic resin are an amide resin, a polyester resin, a polyolefin resin, a styrene resin, an acrylic resin, and a combination of two or more thereof. Among them, preferred is a polyolefin resin.

Examples of the amide resin are nylon 6, nylon 46, nylon 66, nylon 11, nylon 12, nylon 6.10 and nylon 6.12.

The amide resin may be an aromatic polyamide. Examples of the aromatic polyamide are an aromatic polyamide obtained by polymerizing an aromatic amino acid such as p-aminomethyl benzoic acid and p-aminoethyl benzoic acid; and an aromatic polyamide obtained by polymerizing an aromatic dicarboxylic acid with a diamine. Examples of the aromatic dicarboxylic acid are terephthalic acid and isophthalic acid. Examples of the diamine are hexamethylene diamine, undecamethylene diamine, dodecamethylene diamine, 2,2,4-trimethylhexamethylene diamine, 2,4,4-trimethylhexamethylene diamine, metaxylylene diamine, paraxylylene diamine, bis(p-aminocyclohexyl)methane, bis(p-aminocyclohexyl)propane, bis(3-methyl,4-aminocyclohexyl)methane, 1,3-bis(aminomethyl)cyclohexane, and 1,4-bis(aminomethyl)cyclohexane. An aromatic polyamide is preferably polyhexamethylene isophthalamide (nylon 6I).

The above polyester resin is preferably an aromatic polyester resin, and more preferably a polyester resin obtained from an aromatic dicarboxylic acid as a main acid component and an aliphatic glycol as a main glycol component. Examples of the aromatic dicarboxylic acid are terephthalic acid, naphthalenedicarboxylic acid, isophthalic acid, diphenyl ketone dicarboxylic acid, and anthracene dicarboxylic acid. Examples of the aliphatic glycol are a polymethylene glycol having 2 to 10 carbon atoms such as ethylene glycol, trimethylene glycol, tetramethylene glycol, pentamethylene glycol, hexamethylene glycol, and decamethylene glycol; and an aliphatic diol such as cyclohexane dimethanol.

The above styrene resin means a resin containing 50 to 100% by weight of a polymerization unit of a monomer having a styrene skeleton, provided that the total of the resin is 100% by weight. An example of the monomer having a styrene skeleton is a vinyl aromatic compound such as styrene; a nucleus-alkyl-substituted styrene (for example, o-methylstyrene, m-methylstyrene, p-methylstyrene, 2,4-dimethylstyrene, ethylstyrene and p-tert-butylstyrene); and an α-alkyl-substituted styrene (for example, α-methylstyren and α-methyl-p-methylstyren). Among them, styrene is a typical monomer. Examples of a monomer copolymerizable with a monomer having a styrene skeleton are an alkyl ester of an unsaturated carboxylic acid such as an alkyl methacrylate (for example, methyl methacrylate, cyclohexyl methacrylate and isopropyl methacrylate), and an alkyl acrylate (for example, methyl acrylate, ethyl acrylate, butyl acrylate, 2-ethylhexylacrylate, and cyclohexyl acrylate); an unsaturated carboxylic acid such as methacrylic acid, acrylic acid, itaconic acid, maleic acid, fumalic acid, and cinnamic acid; and an unsaturated dicarboxylic anhydride such as maleic anhydride, itaconic anhydride, ethylmaleic anhydride, methylitaconic anhydride, and chloromaleic anhydride.

The above acrylic resin means a resin containing 50 to 100% by weight of a polymerization unit of acrylic acid, a derivative of acrylic acid, methacrylic acid, or a derivative of methacrylic acid, provided that the total of the resin is 100% by weight. An example of the derivative of acrylic acid is an acrylic ester such as methyl acrylate, ethyl acrylate, butyl acrylate, isopropyl acrylate, and 2-ethylhexyl acrylate. An example of the derivative of methacrylic acid is a methacrylic ester such as cyclohexyl methacrylate, tert-butylcyclohexyl methacrylate, and methyl methacrylate. Examples of the acrylic resin are respective homopolymers of those monomers, and a copolymer of two or more of those monomers.

The above polyolefin resin means a homopolymer of ethylene, propylene or an α-olefin having 4 to 12 carbon atoms, a combination of two or more of these homopolymers, a copolymer of two or more of these monomers, and a modified polymer obtained by modifying above homopolymer or copolymer with an unsaturated carboxylic acid and/or its derivative. Examples of the α-olefin are 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, and 1-dodecene. Among them, preferred is 1-butene, 1-pentene, 1-hexene or 1-octene. Examples of the polyolefin resin are an ethylene homopolymer; a propylene homopolymer; an ethylene-propylene random copolymer; an ethylene-α-olefin random copolymer; a propylene-α-olefin random copolymer; an ethylene-propylene-α-olefin random copolymer; a copolymer obtained by homopolymerizing propylene, and then copolymerizing ethylene with propylene in the presence of the previously-homopolymerized polypropylene; a modified polymer obtained by modifying above homopolymer or copolymer with an unsaturated carboxylic acid and/or its derivative; and a combination of two or more of these polyolefin resins. Among them, preferred is polypropylene.

When the polyolefin resin is a propylene homopolymer, its isotactic pentad fraction is preferably 0.95 to 1.00, more preferably 0.96 to 1.00, and further preferably 0.97 to 1.00. The isotactic pentad fraction means a fraction of an isotactic chain contained in a molecular chain of the propylene homopolymer, on a pentad basis; in other words, a fraction of a propylene monomer unit existing in the center of a chain consisting of a sequential meso-combination of five propylene monomer units, which is measured by a ¹³C-NMR method disclosed in Macromolecules, 6, 925 (1973) authored by A. Zambelli et al., provided that an NMR absorption peak is identified by a method disclosed in Macromolecules, 8, 687 (1975).

When the polyolefin resin is the above-mentioned copolymer obtained by homopolymerizing propylene, and then copolymerizing ethylene with propylene in the presence of the previously-homopolymerized polypropylene, an isotactic pentad fraction of its homopolypropylene part is preferably 0.95 to 1.00, more preferably 0.96 to 1.00, and further preferably 0.97 to 1.00.

Regarding (i) a content of an ethylene unit contained in the above ethylene-propylene random copolymer, (ii) a content of an α-olefin unit contained in the above propylene-α-olefin random copolymer, (iii) a total content of an ethylene unit and an α-olefin unit contained in the above ethylene-propylene-α-olefin random copolymer, and (iv) a content of an ethylene unit contained in the above copolymer obtained by homopolymerizing propylene, and then copolymerizing ethylene with propylene in the presence of the previously-homopolymerized polypropylene, these contents (i) to (iv) are preferably 10% by mol to less than 50% by mol, provided that the total of ethylene units and propylene units is 100% by mol (in case of (i) and (iv)), the total of propylene units and α-olefin units is 100% by mol (in case of (ii)), or the total of ethylene units, propylene units and α-olefin units is 100% by mol (in case of (iii)). The above-mentioned term such as “ethylene unit” means a polymerization unit of a monomer such as ethylene. The above content of an ethylene unit, content of a propylene unit, and content of an α-olefin unit are measured by an infrared method (IR method) or a nuclear magnetic resonance method (NMRmethod), which are disclosed in “Kobunshi Bunseki Handbook (New Edition)” edited by Chemical Society of Japan and Polymer Analysis Research Society, published by Kinokuniya Co., Ltd. (1995).

A propylene unit-containing polymer such as the above propylene homopolymer, ethylene-propylene random copolymer, propylene-α-olefin random copolymer, ethylene-propylene-α-olefin random copolymer, and copolymer obtained by homopolymerizing propylene, and then copolymerizing ethylene with propylene in the presence of the previously-homopolymerized polypropylene can be produced by a polymerization method such as a solution polymerization method, a slurry polymerization method, a bulk polymerization method, a gas phase polymerization method, and a combined method of two or more thereof. A production process of these polymers is specifically disclosed in a document such as “New Polymer Production Process” edited by Yasuji SAEKI, published by Kogyo Chosakai Publishing, Inc. (1994), JP 4-323207A and JP 61-287917A. Examples of a preferable polymerization catalyst for producing these polymers are a multi-site catalyst such as a catalyst obtained by using a solid catalyst component containing a titanium atom, a magnesium atom and a halogen atom, and a single-site catalyst such as a metallocene catalyst. Among them, preferred in the present invention is a multi-site catalyst obtained by using a solid catalyst component.

Among the above modified polymer obtained by modifying with an unsaturated carboxylic acid and/or its derivative, examples of a modified polymer obtained by modifying a propylene unit-containing polymer with an unsaturated carboxylic acid and/or its derivative are the following commercially-available modified polymers: MODIPER (trade name) manufactured by NOF Corporation; BLEMMER CP (trade name) manufactured by NOF Corporation; BONDFAST (trade name) manufactured by Sumitomo Chemical Co., Ltd.; BONDINE (trade name) manufactured by Sumitomo Chemical Co., Ltd.; REXPEARL (trade name) manufactured by Japan Polyethylene Corporation; ADMER (trade name) manufactured by Mitsui Chemicals, Inc.; MODIC AP (trade name) manufactured by Mitsubishi Chemical Corporation; POLYBOND (trade name) manufactured by Chemtura Japan Limited.; and YUMEX (trade name) manufactured by Sanyo Chemical Industries, Ltd.

Examples of the above unsaturated carboxylic acid are maleic acid, fumaric acid, itaconic acid, acrylic acid and methacrylic acid.

Examples of the above unsaturated carboxylic acid derivative are acid anhydrides of the above unsaturated carboxylic acids, esters thereof, amides thereof, imides thereof, and metal salts thereof. Specific examples of the unsaturated carboxylic acid derivative are maleic anhydride, itaconic anhydride, methyl acrylate, ethyl acrylate, butyl acrylate, glycidyl acrylate, methyl methacrylate, ethyl methacrylate, butyl methacrylate, glycidyl methacrylate, 2-hydroxyethyl methacrylate, monoethyl maleate, diethylmaleate, monomethyl fumarate, dimethyl fumarate, acrylamide, methacrylamide, monoamides of maleic acid, diamides of maleic acid, monoamides of fumaric acid, maleimide, N-butylmaleimide, and sodium methacrylate. The above unsaturated carboxylic acid or its derivative can be replaced with a compound such as citric acid and malic acid, which may be converted into an unsaturated carboxylic acid or its derivative by a reaction such as a dehydration reaction occurring in a modifying step. The above unsaturated carboxylic acid or its derivative is preferably glycidyl acrylate, glycidyl methacrylate, maleic anhydride, or 2-hydroxyethyl methacrylate.

The above modified polymer contains a unit derived from the above unsaturated carboxylic acid and/or its derivative in an amount of preferably 0.1 to 10% by weight, in order to improve mechanical strength of the modified polymer such as impact strength, durability and stiffness, provide that the total amount of the modified polymer is 100% by weight. The amount can be determined based on a characteristic absorption of the unit in an IR or NMR spectrum.

Examples of a production method of the above modified polymer are a solution method, a bulk method, a melt-kneading method, and a combined method of two or more thereof.

Examples of the above solution method, bulk method or melt-kneading method are disclosed in a document such as “Jitsuyo Polymer Alloy Designing” authored by Humio IDE, published by Kogyo Chosakai Publishing Co., Ltd. (1996); Prog. Polym. Sci., 24, 81-142 (1999); JP 2002-308947A; JP 2004-292581A; JP 2004-217753A; and JP 2004-217754A.

The above thermoplastic resin may be combined with inorganic fillers such as talc, mica, clay, calcium carbonate, aluminum hydroxide, magnesium hydroxide, wollastonite, barium sulfate, silica, calcium silicate, and potassium titanate; antioxidants such as phenol series antioxidants, thioether series antioxidants and organic phosphorus series antioxidants; thermal stabilizers such as hindered amine series thermal stabilizers; ultraviolet absorbing agents such as benzophenone series ultraviolet absorbing agents, benzotriazole series ultraviolet absorbing agents, and benzoate series ultraviolet absorbing agents; antistatic agents such as nonion series antistatic agents, cation series antistatic agents, and anion series antistatic agents; dispersing agents such as bisamide series dispersing agents, wax series dispersing agents, and organic metallic salt series dispersing agents; lubricants such as amide series lubricants, wax series lubricants, organic metallic salt series lubricants, and ester series lubricants; decomposition agents such as oxide series decomposition agents and hydrotalcite series decomposition agents; metal deactivators such as hydrazine series metal deactivators and amine series metal deactivators; flame retardants such as bromine-containing organic flame retardants, phosphoric acid series flame retardants, antimony trioxide, magnesium hydroxide, and red phosphorus; crystal nucleating agents such as organic phosphoric acid series crystal nucleating agents and sorbitol series crystal nucleating agents; pigments such as organic pigments and inorganic pigments; organic fillers; antibacterial agents such as organic antibacterial agents and inorganic antibacterial agents; or elastomers such as styrene series elastomers, polyester series elastomers, polyurethane series elastomers, and PVC series elastomers. Among these elastomers, preferred is a styrene series elastomer. Examples of the styrene series elastomer are (i) a polymer obtained by copolymerizing styrene and/or its derivative with a conjugated diene-containing compound, and (ii) a polymer obtained by hydrogenating above polymer (i). The styrene series elastomer may have a polar group such as a carbonyl group, a hydroxyl group and an amino group, at an end of its molecular chain and/or within its molecular chain.

Examples of the fiber used in the present invention are inorganic fibers such as glass fibers and metal fibers; and organic fibers such as aromatic polyamide fibers, polyester fibers and nylon fibers. Among them, preferred is an organic fiber, and more preferred is a polyester fiber.

The polyester fiber is preferably a polyalkylene terephthalate fiber or a polyalkylene naphthalate fiber, and particularly preferably a polyalkylene naphthalate fiber. The polyalkylene naphthalate fiber is preferably a fiber containing 90% by mol or more, and preferably 95% by mol or more of repeating units of an alkylene-2,6-naphthalate or an alkylene-2,7-naphthalate, provided that the total amount of the repeating units is 100% by mol. The alkylene group therein is an aliphatic alkylene group or an alicyclic alkylene group, and is preferably a linear alkylene group having 2 to 4 carbon atoms. The above polyalkylene naphthalate fiber is more preferably a polyethylene naphthalenedicarboxylate fiber, and particularly preferably a polyethylene-2,6-naphthalate fiber.

The fiber contained in the resin composition of the present invention contains 10 to 100% by weight, preferably 30 to 100% by weight, and further preferably 50 to 100% by weight of a diameter-varying fiber which has an enlarged diameter at its one or both ends, provided that the total of the fiber contained in the resin composition is 100% by weight. The diameter-varying fiber in the present invention has an enlarged diameter at its one or both ends. The enlarged diameter is generally larger than any other diameter of the fiber outside the enlarged diameter part(s) of the fiber at one or both ends. Preferably, the maximum diameter of the enlarged diameter part (s) is 1.1 to 5.0 times larger, more preferably 1.3 to 5.0 times larger than any other diameter of the fiber outside the enlarged diameter parts. In a further preferred embodiment, the fiber with an enlarged diameter has a substantially uniform diameter outside the enlarged diameter part(s) at one or both ends, and also in this embodiment, the maximum diameter of the enlarged diameter part(s) is preferably 1.1 to 5.0 times larger, more preferably 1.3 to 5 times larger than the diameter in the part of the fiber where its diameter is substantially uniform, as determined by the method set out below.

A shape and diameter of the fiber used in the present invention can be evaluated, for example, by (i) observing the fiber with an optical microscope (model number: SZX 16) manufactured by Olympus Corporation, (ii) taking its photograph with a digital camera (model number: DP 20) manufactured by Olympus Corporation for the above optical microscope, and (iii) analyzing the obtained photographic image.

A specific embodiment of the step (1) of above process-1 comprises, for example, the steps of (i) cutting a continuous fiber under the condition that its cutting spot is heated to its melting temperature or higher, whereby the heated spot of the continuous fiber has a molten state, and (ii) cooling and solidifying the resultant cut fibers. A more specific embodiment thereof comprises, for example, the step of placing a cutting blade firmly on a continuous fiber, wherein the cutting blade is heated to a melting temperature of the continuous fiber, or higher, thereby cutting the fiber. Examples of such a cutting blade are a hot knife, a soldering iron, and a blade of a cutting device. Among them, preferred is an embodiment using a hot knife, from a viewpoint of easiness of melting and cutting of a continuous fiber.

The continuous fiber used in process-1 of the present invention, and the continuous fiber bundle used in process-2 and process-3 thereof may be bundled with a fiber-bundling agent. Examples of the fiber-bundling agent are a polyolefin resin, a polyurethane resin, a polyester resin, an acrylic resin, an epoxy resin, starch, and vegetable oil. These fiber-bundling agents may be combined with a lubricant agent such as an acid-modified polyolefin resin, a surface treatment agent, and paraffin wax.

The continuous fiber used in process-1, and the continuous fiber bundle used in process-2 and process-3 may be treated previously with a surface treatment agent, in order to improve their compatibility with a thermoplastic resin, or their adhesiveness thereto. Examples of the surface treatment agent are a silane coupling agent, a titanate coupling agent, an aluminum coupling agent, a chromium coupling agent, a zirconium coupling agent, and a borane coupling agent. Among them, preferred is a silane coupling agent or a titanate coupling agent, and particularly preferred is a silane coupling agent.

Examples of the silane coupling agent are triethoxysilane, vinyltris(β-methoxyethoxy)silane, γ-methacryloxypropyltrimethoxysilane, γ-glycidoxypropyltrimethoxysilane, β-(3,4-epoxycyclohexyl)ethyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, γ-mercaptopropyltrimethoxysilane, and γ-chloropropyltrimethoxysilane. Among them, preferred are aminosilanes, and more preferred is γ-aminopropyltriethoxysilane or N-β-(aminoethyl)-γ-aminopropyltrimethoxysilane.

Examples of a method for treating a fiber with a surface treatment agent are an aqueous solution method, an organic solvent method, and a spray method, which are all known in the art.

The resin composition of the present invention contains the fiber whose number-average length is preferably 1 to 50 mm, and particularly preferably 2 to 20 mm, in order to improve mechanical strength such as stiffness and impact strength of the resin composition, and from a viewpoint of ease of its production and molding. The number-average length can be measured by a method comprising the steps of (i) separating fibers contained in a resin composition by soxhlet extraction by use of a solvent such as xylene, (ii) selecting arbitrarily 300 fibers from the separated fibers, (iii) taking a microscope photograph of these 300 fibers, (iv) analyzing an image of the microscope photograph, and (v) calculating their number-average length. The resin composition pellet obtained in process-2 and process-3 has the same length as length of fibers contained in the resin composition pellet.

The resin composition of the present invention comprises 55 to 95 parts, and preferably 70 to 95 parts by weight of a thermoplastic resin, and 5 to 45 parts, and preferably 5 to 30 parts by weight of a fiber, provided that the total of the thermoplastic resin and the fiber is 100 parts by weight.

Examples of a specific embodiment of step (2) in process-1 are the following embodiments (a) and (b):

(a) an embodiment comprising the steps of blending all components, thereby preparing a homogeneous blend, and then melt-kneading the blend; and

(b) an embodiment comprising the steps of blending arbitrary combinations of components, respectively, thereby preparing respective homogeneous blends, and then melt-kneading these blends.

The blending in above embodiments (a) and (b) can be carried out, for example, by use of a blending machine such as a Henschel mixer, a ribbon blender and a blender. The melt-kneading therein can be carried out, for example, by use of a kneading machine such as a Banbury mixer, PLASTOMILL, a BRABENDER plastograph, and a kneader (for example, mono-axial extruder and double screw extruder).

The melt-kneading in step (2) of process-1 is carried out generally at temperature higher by about 20° C. to about 100° C. than a melting temperature of the thermoplastic resin. Therefore, when the thermoplastic resin is a polypropylene resin having melting temperature of about 160° C., its melt-kneading is carried out generally at about 180° C. to 260° C., and may be carried out at about 300° C. in case that the fiber is a glass fiber or a metal fiber.

Step (1) in process-2 and process-3 can be carried out by a pultrusion process, known in the art. Examples of a specific embodiment of the pultrusion process are the following embodiments (i) to (iii):

(i) an embodiment comprising the steps of (i-1) passing a continuous fiber bundle through an impregnating vessel containing an emulsion, suspension or solution of a thermoplastic resin, thereby impregnating the continuous fiber bundle with the thermoplastic resin, and then (i-2) removing the solvent contained therein;

(ii) an embodiment comprising the steps of (ii-1) spraying a continuous fiber bundle with powder of a thermoplastic resin, or passing a continuous fiber bundle through a vessel containing powder of a thermoplastic resin, thereby adhering the powder to the continuous fiber bundle, and then (ii-2) melting the thermoplastic resin powder, thereby impregnating the continuous fiber bundle with the thermoplastic resin; and

(iii) an embodiment comprising the step of supplying a thermoplastic resin to a crosshead, for example, from an extruder, while passing a continuous fiber bundle through the crosshead, thereby impregnating the continuous fiber bundle with the thermoplastic resin.

Among them, preferred is embodiment (iii), and more preferred is a pultrusion process using a crosshead disclosed in a patent document such as JP 3-272830A. The temperature for melting the thermoplastic resin in embodiment (ii), and the temperature of the thermoplastic resin supplied to the crosshead in embodiment (iii) are temperature pursuant to the melt-kneading temperature in step (2) of process-1.

An example of a specific embodiment of step (2) in process-2 is an embodiment comprising the step of cutting the thermoplastic resin-impregnated continuous fiber bundle with a blade of a pelletizer, wherein the blade is heated to a melting temperature of the fiber, or higher.

An example of a specific embodiment of step (3) in process-3 is an embodiment comprising the step of placing a metal plate firmly on one or both ends of the pellet, wherein the metal plate is heated to a melting temperature of the fiber, or higher, thereby forming a diameter-enlarged part at the one or both ends of the fiber.

Since process-2 and process-3 form a diameter-varying fiber in a step after step (1) of these respective processes, step (1) thereof can use a fiber having a substantially-uniform diameter along its longitudinal direction.

The resin composition in the present invention can be molded to an electrical product such as a housing; an automobile part such as a console, a lever and a steering wheel; and a building component such as a curtain rail, by a molding method such as an injection molding method, an injection compression molding method, a gas assisted molding method, an extrusion molding method, and a supercritical injection-expansion molding method.

### EXAMPLE

The present invention is explained in more detail with reference to the following Example, which does not limit the present invention.

### Example 1

### 1. Production of Diameter-Varying Fiber

Chips of polyethylene naphthalenedicarboxylate having an inherent viscosity of 0.62 dl/g were previously dried at 120° C. for 2 hours under vacuum of 65 Pa. These previously-dried chips were subjected to solid-phase polycondensation at 240° C. for 10 to 13 hours under vacuum of 65 Pa, thereby obtaining chips of polyethylene naphthalenedicarboxylate resin having an inherent viscosity of 0.84 dl/g.

These chips were discharged from a spinneret having 144 circular spinning holes (diameter: 0.6 mm) in their molten state at 310° C., while regulating the discharge rate such that the resultant spun and stretched fibers had fineness of 1,670 dtex. The discharged filamentous materials were passed though a heated spinning tube, and then were air-cooled at 25° C.

The air-cooled filamentous materials were (i) contacted with a yarn-making oily agent by means of an apparatus for feeding the yarn-making oily agent at a constant feed rate, then (ii) guided to a take-up roller, and (iii) rolled up with a winding machine, thereby obtaining unstretched fibers, wherein the yarn-making oily agent was a mixture of rapeseed oil, an adduct of 17 moles of ethylene oxide to hardened castor oil, and dioctyl sulfosuccinate, and the constant feed rate was such that 0.3% by weight of the yarn-making oily agent was contained in the unstretched fibers, the total of the unstretched fibers being 100% by weight.

The unstretched fibers were (i) firstly stretched fivefold between a feed roller and a firstly-stretching roller, wherein the feed roller was heated at 150° C. and was rotating at a circumferential speed of 130 m/minute, and the firstly-stretching roller was heated at 180° C., (ii) secondly stretched between the firstly-stretching roller and a secondly-stretching roller heated at 180° C., and (iii) rolled up on a winder, thereby obtaining stretched fibers, provided that the above firstly-stretched fibers were passed through a non-contact set-bath (length: 70 cm) heated at 230° C., between the firstly-stretching roller and a secondly-stretching roller, thereby subjecting the fibers to a fixed-length thermal treatment. The obtained stretched fibers consisted of many single fibers, and each of the single fibers was found to have a constant diameter of 35 μm. The stretched fibers were found to have melting temperature of 272° C.; fineness of 1,670 dtex; inherent viscosity of 0.90; tensile strength of 7.7 cN/dtex; tensile modulus of 165 cN/dtex; dry-thermal shrinkage ratio of 5.4% at 180° C.; high modulus; and excellent dimension stability.

The stretched fibers were cut in the length of 10 mm with a hot knife heated to 300° C., thereby obtaining thermally-cut fibers, wherein the hot knife manufactured by Hakko Corporation had a trade name of HOT KNIFE SOLDERING IRON SET 40 W, and a basal diameter (Φ) of 4 mm. The obtained thermally-cut fibers had an enlarged diameter at their both ends, and the enlarged diameter was 1.3 to 2.5 times other substantially-uniform diameter.

### 2. Production of Thermoplastic Resin Composition

There were melt-kneaded (i) 10 parts by weight of the above-obtained thermally-cut fibers, (ii) 81 parts by weight of a propylene homopolymer (thermoplastic resin) having a melt flow rate (MFR) of 100 g/10 minutes and an isotactic pentad fraction of 0.98, produced by a gas phase polymerization method using a solid catalyst component disclosed in JP 7-216017A, and (iii) 9 parts by weight of a modified styrene series elastomer modified by a polar group-containing compound having a trade name of f-DYNARON (8630 P), manufactured by JSR corporation, at 200° C. for 5 minutes with LABO PLASTOMILL (Model C) having a screw rotation speed of 80 rpm, manufacture by Toyo Seiki Kogyo Co., Ltd., thereby obtaining a fiber-containing thermoplastic resin composition.

The obtained resin composition was molded to an evaluation sample by a method comprising the steps of (i) preheating at 200° C. for 5 minutes, then (ii) pressing at 200° C. for 5 minutes under a pressure of 10 MPa, and (iii) cold pressing at 30° C. for 5 minutes under a pressure of 1 MPa, thereby obtaining an evaluation sample having a size of 65 mm×65 mm×2 mm (thickness). The sample was found to have flexural modulus of 1,470 MPa, and was found to contain fibers having number-average length of 9 mm, and was not broken in a falling-weight-impact test. Among the fibers used for measuring the number-average length, 70% by weight thereof was found to have an enlarged diameter at their one or both ends, and the enlarged diameter was 1.3 to 2.5 times other substantially-uniform diameter. Results are shown in Table 1.

### Comparative Example 1

Example 1 was repeated except that the stretched fibers were cut in the length of 10 mm with a sharp knife at room temperature, thereby obtaining non-thermally-cut fibers. The evaluation sample was found to have flexural modulus of 1,470 MPa, and was found to contain fibers having number-average length of 8 mm, and was penetrated by an impact striker in a falling-weight-impact test. The fibers used for measuring the number-average length were found to have no enlarged diameter at their ends. Results are shown in Table 1.

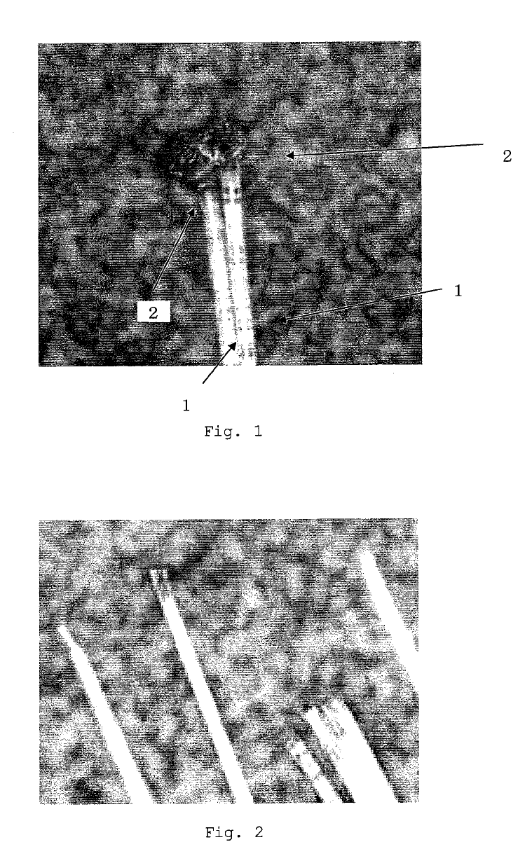

The above fiber diameter was measured by a method comprising the steps of (i) taking a photograph with a digital camera (model number: DP 20) connected to an optical microscope (model number: SZX 16) manufactured by Olympus Corporation, the digital camera being manufactured by Olympus Corporation for an optical microscope, and (ii) analyzing an image of the microscope photograph obtained. FIG. 1 shows an optical photomicrograph of a diameter-varying fiber 1 separated from the resin composition produced in Example 1, and its diameter-enlarged part 2. FIG. 2 shows an optical photomicrograph of a fiber separated from the resin composition produced in Comparative Example 1.

The above flexural modulus (unit: MPa) was measured with an automatic reading Orzen stiffness tester manufactured by Toyo Seiki Kogyo Co., Ltd., according to a method prescribed in ASTM D747-58T.

The above falling-weight-impact test was performed by a method comprising the steps of (i) falling an impact striker (weight: 1 kg, diameter: ½ inch) onto an evaluation sample, and (ii) observing its destruction state.

The above number-average fiber length (unit: mm) was determined by a method comprising the steps of (i) separating fibers contained in an evaluation sample by soxhlet extraction (solvent: xylene), and (ii) measuring number-average fiber length of the separated fibers, based on a method disclosed in JP 2002-5924A.

TABLE 1

| | | Comparative |
|---|---|---|
| | Example 1 | Example 1 |
| Production of resin composition | | |
| (1) Fiber | | |
| Kind | thermally-cut | non-thermally-cut |
| | fibers | fibers |
| Amount (parts by weight) | 10 | 10 |
| (2) Propylene homopolymer | | |
| Amount (parts by weight) | 81 | 81 |
| (3) Modified styrene series elastomer | | |
| Amount (parts by weight) | 9 | 9 |
| Evaluation of resin composition | | |
| (1) Flexural modulus (MPa) | 1,470 | 1,470 |
| (2) Falling-weight-impact test | non-broken | penetrated by |
| | | impact striker |
| (3) Number-average fiber length (mm) | 9 | 8 |

1. A thermoplastic resin composition comprising:
55 to 95 parts by weight of a thermoplastic resin; and
5 to 45 parts by weight of a fiber containing 10 to 100% by weight of a diameter-varying fiber which has an enlarged diameter at its one or both ends;
provided that the total of the thermoplastic resin and the fiber contained in the thermoplastic resin composition is 100 parts by weight, and the total of the fiber contained in the thermoplastic resin composition is 100% by weight.

2. The resin composition according to claim 1, wherein the fiber contained in the resin composition is 1 to 50 mm in its number-average length.

3. The resin composition according to claim 1, wherein the thermoplastic resin is a polyolefin resin.

4. The resin composition according to claim 1, wherein the fiber is a polyester fiber.

5. The resin composition according to claim 4, wherein the polyester fiber is a polyalkylene terephthalate fiber or a polyalkylene naphthalate fiber.

6. A process for producing a thermoplastic resin composition comprising:
55 to 95 parts by weight of a thermoplastic resin; and
5 to 45 parts by weight of a fiber containing 10 to 100% by weight of a diameter-varying fiber which has an enlarged diameter at its one or both ends;
provided that the total of the thermoplastic resin and the fiber contained in the thermoplastic resin composition is 100 parts by weight, and the total of the fiber contained in the thermoplastic resin composition is 100% by weight, the process comprising the steps of:
(1) cutting a continuous fiber under the condition that its cutting spot is heated to its melting temperature or higher, thereby preparing a diameter-varying fiber; and
(2) melt-kneading a mixture containing the diameter-varying fiber and a thermoplastic resin.

7. The process according to claim 6, wherein the fiber contained in the resin composition is 1 to 50 mm in its number-average length.

8. The process according to claim 6, wherein the thermoplastic resin is a polyolefin resin.

9. The process according to claim 6, wherein the fiber is a polyester fiber.

10. The process according to claim 9, wherein the polyester fiber is a polyalkylene terephthalate fiber or a polyalkylene naphthalate fiber.

11. A process for producing a thermoplastic resin composition pellet comprising:
55 to 95 parts by weight of a thermoplastic resin; and
5 to 45 parts by weight of a fiber containing 10 to 100% by weight of a diameter-varying fiber which has an enlarged diameter at its one or both ends;
provided that the total of the thermoplastic resin and the fiber contained in the thermoplastic resin composition is 100 parts by weight, and the total of the fiber contained in the thermoplastic resin composition is 100% by weight, the process comprising the steps of:
(1) impregnating a continuous fiber bundle with a thermoplastic resin under drawing the continuous fiber bundle, thereby preparing a thermoplastic resin-impregnated continuous fiber bundle; and
(2) cutting the thermoplastic resin-impregnated continuous fiber bundle under the condition that its cutting spot is heated to melting temperature of the fiber, or higher.

12. The process according to claim 11 wherein the fiber contained in the resin composition is 1 to 50 mm in its number-average length.

13. The process according to claim 11 wherein the thermoplastic resin is a polyolefin resin.

14. The process according to claim 11 wherein the fiber is a polyester fiber.

15. The process according to claim 14, wherein the polyester fiber is a polyalkylene terephthalate fiber or a polyalkylene naphthalate fiber.

16. A process for producing a thermoplastic resin composition pellet comprising:
55 to 95 parts by weight of a thermoplastic resin; and
5 to 45 parts by weight of a fiber containing 10 to 100% by weight of a diameter-varying fiber which has an enlarged diameter at its one or both ends; the process comprising the steps of:
(1) impregnating a continuous fiber bundle with a thermoplastic resin under drawing the continuous fiber bundle, thereby preparing a thermoplastic resin-impregnated continuous fiber bundle;
(2) cutting the thermoplastic resin-impregnated continuous fiber bundle under the condition that its cutting spot has temperature lower than melting temperature of the fiber, thereby preparing a pellet; and
(3) heating one or two cut ends of the pellet at melting temperature of the fiber, or higher.

17. The process according to claim 16, wherein the fiber contained in the resin composition is 1 to 50 mm in its number-average length.

18. The process according to claim 16, wherein the thermoplastic resin is a polyolefin resin.

19. The process according to claim 16, wherein the fiber is a polyester fiber.

20. The process according to claim 19, wherein the polyester fiber is a polyalkylene terephthalate fiber or a polyalkylene naphthalate fiber.
